(19) United States
(12) Patent Application Publication
(10) Pub. No.: US 2006/0176691 A1
(43) Pub. Date: Aug. 10, 2006

(54) Liquid cooled flashlight with optional display

(76) Inventors: Alexander Joseph Kalogroulis, Surrey (GB); Ming Yiu Wong, Kowloon (HK)

Correspondence Address: Curt Harrington, Suite 250, 6300 State University Drive, Long Beach, CA, 90815, US

(21) Appl. No.: 11/053,357

(22) Filed: Feb. 7, 2005

(51) Int. Cl. F21L 4/04; F21V 29/00

(52) U.S. Cl. 362/202; 362/294

(57) ABSTRACT

A small hand-held tubular shaped flashlight utilizes a liquid to absorb heat energy from a high intensity light source such as an LED base member such as a heat sink, capsule or other light source, and assists in absorbance and transport of heat energy. The liquid preferably transfers the heat throughout the long cylindrical handle, and utilizes the surface area of the long flashlight body for even heat rejection without localized hot spots. In the alternative, a liquid can store the heat through melting/crystallization, where the liquid takes the form of a solid with low melting point (such as a wax) that melts during use but re-solidifies or crystallizes during periods of non-use. The use of a liquid jacket around these batteries also makes the flashlight attractive for low temperature service where the heat from the LED can be used to warm the batteries.

### FIELD OF THE INVENTION

The present invention relates to the field of lighting structures using high intensity lamps typically from 1 to 10 watts and have the need to reject a significant amount of heat to maintain bulb life and stable operation.

### BACKGROUND OF THE INVENTION

High temperature lamps, such as light emitting diodes (LEDs) create a heat problem in the lighting field. Using LEDs as an example, they typically have a power typically ranging from one to five watts and have been employed in heavy duty service in large devices which allow for extended area cooling. High temperature LEDs are more energy efficient but typically have a need to reject significant amounts of heat from a small area. The 5500° C. color temperature is made at the expense of a high heat rejection rate which would cause the LED and its surrounding electronics to rise to the 95° C. to 120° C. under general non-insulating conditions.

High heat from the LED is undesirable for a number of reasons. First, if the heat is not dissipated it could burn the user or damage the housing components. Second, the thermal efficiency is dependent upon maintaining a relatively low temperature at the light source over time. At 25° C. the LED has its maximum sustained efficiency. Over a time of usage of about 500 hours where the junction temperature is allowed to rise to 35° C. the efficiency drops to 90% of maximum. At 75° C. the efficiency drops to 75% and at 85° C. the efficiency drops to 65% over time. As such, to allow operation at a temperature of more than 25° C. will result in a diminution in efficiency over time. Although some bulbs can fail completely from malfunction, the prognosis for users of these types of bulbs is to either keep the temperature down or suffer a continual loss in efficiency over the life of the bulb. Diminution in performance over time is proportional to the extent that temperature is not maintained.

Another performance parameter is the operational voltage range which is typically narrow at between six to seven volts at which a current of about 0.7 amps are delivered. The above profile indicates that for maximum effectiveness, the lamp has to perform at a high efficiency all the time, while handling the heat load output. Dimming is typically achieved by a circuit induced pulse width modulation.

The control of temperature is also a safety issue. Even a conventional electric resistance flashlight can burn a surface and melt a lens if left on adjacent a light absorbing surface. The increased light production efficiency reduces the forward heat radiation making the light safer, but the heat around the bulb must be maintained at nearly room temperature. This type of constraint requires a significant surface area to insure that the temperature adjacent the bulb is no more than a few degrees above room temperature.

The problems associated with heat rejection in large industrial applications are solved with fans, refrigeration units or the like. Other applications take advantage of low temperature ambient surroundings like the outdoors. The heat rejection problem has prevented effective utilization of high intensity LEDs in more miniaturized applications.

Further, in other applications where portability is not an issue, a required hight lumen density, especially where traditional expanded area heat fin is not possible nor practical, can also create heat load problems.

### SUMMARY OF THE INVENTION

A small hand-held tubular shaped flashlight utilizes a liquid to absorb heat energy from a high intensity LED base member such as a heat sink, capsule or other light source, and assists in absorbance and transport of heat energy. The liquid preferably transfers the heat throughout the long cylindrical handle, and utilizes the surface area of the long flashlight body for even heat rejection without localized hot spots. In the alternative, a liquid can store the heat through melting/crystallization, where the liquid takes the form of a solid with low melting point (such as a wax) that melts during use but re-solidifies or crystallizes during periods of non-use.

Active methods can also be employed by adding a fan or similar device to the body of the flashlight to actively move air or liquid over a heat transfer surface to increase the rate of heat transfer. The advantages of the invention include the ability to utilize lower cost materials. The inventive flashlight may preferably use five and ten watt LED modules. The flashlight of the invention takes advantage of all heat transfer mechanisms from the LED to ambient, both light, radiative, and heat flow through the heat sink, which may also include conduction, convection and direct radiation. The heat transfer mechanism can handle a steady state heat transfer for over three hours and in the case of liquid heat storage can accommodate over three hours of heat transfer.

The size of the flashlight accommodates battery pack sizes for powering the flashlight for 5 hour and 2.5 hour battery life for combinations of 3.6 volt Lithium, 3.0 volt Lithium, 1.5 volt alkaline and 1.2 volt NiMH batteries. The use of a liquid jacket around these batteries also makes the flashlight attractive for low temperature service where the heat from the LED can be used to warm the batteries.

### BRIEF DESCRIPTION OF THE DRAWINGS

These and other aspects of the invention will be better understood from the following description in which reference is made to the drawing in which:

FIG. 1 is a sectional schematic view illustrating the overall positioning of the battery compartment, cooling liquid space and LED mounted at the end.

### DETAILED DESCRIPTION OF THE PREFERRED EMBODIMENT

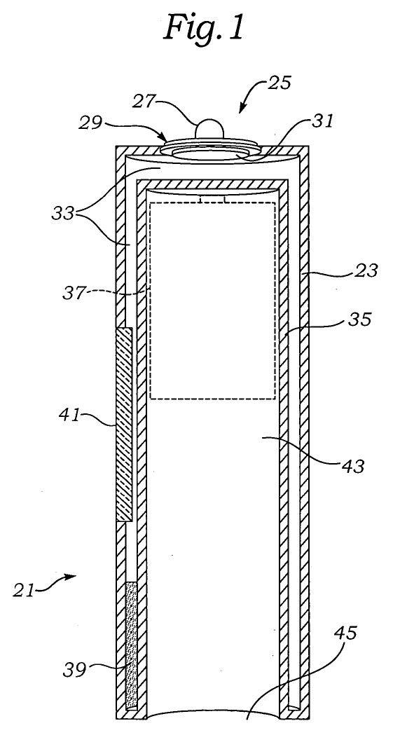

Referring to FIG. 1, a basic embodiment of the high intensity LED flashlight 21 is shown. The reflector and other optics have been removed for clarity, as is the case with modular flashlights having threaded “screw on” or “slide on” heads which may include reflectors and light spreading optics.

An exterior housing 23 may also support a light emitting diode (LED) assembly 25 which may include a light emitting diode 27 mounted atop an electronics package 29. The electronics package may include a heat sink or heat rejection surface 31 which faces the inside of the exterior housing 23.

The heat rejection surface 31 is available to what is shown as a fluid space 33 between the inside of the exterior housing 23 and an exterior surface of a battery chamber 35. The overall representation is a simplistic schematic representation, but in fact the chambering of liquid within this space toward and away from the heat rejection surface 31 is highly desirable. A configuration which prevents stagnation and which may take advantage of density differences, may be employed. Check valves and other one way flow urging devices can be employed. Spaces which are other than can be employed, as well as other specialized chambers and fluid flow channels.

A battery 37 is shown as it might appear within the battery chamber 35. A fluid 39 introduced in the fluid space 33 between the exterior housing 23 and battery chamber 35 is free to circulate into contact with the hot heat rejection surface 31 and thence to circulate within the fluid space 33 to reject heat through the exterior housing 23 to the ambient atmosphere, as well as to provide some warming to the battery chamber 35. The materials chosen for the exterior housing 23 and exterior surface of a battery chamber 35 can help to determine whether the heat is to be predominantly rejected through the exterior housing 23 and insulated from the battery chamber 35, or, in the case of low temperature service, whether heat is to be held in and used to provide heat to the battery chamber 35.

The exterior housing 23 may include a clear window section 41 to enable users to check and maintain the integrity of the fluid 39 which can be a cooling fluid or melting fluid/crystallization solid. Further, particulate structures can be introduced into the fluid 39 to enable a greater visual detection of the motion of the fluid 39 as it moves past the clear window section 41. The fluid can have glitter or other light interactive materials to increase visualization, as well as colors of liquid and multi-phase liquids, or two hase liquids such as oil and water, to produce a pattern at the clear window section 41.

Gravity can be used, either with fluid space 33 or with other shaped spaces, to help move fluid 39 around. Ideally in a passive system the environment and expected treatment of the light apparatus, any light apparatus should facilitate cooling. Handling of the flashlight 21 can increase the amount of fluid 39 flow by the use of check valves or elements which have a differential action more in one direction than the other.

Ideally, the electrical connections (excluded for clarity) will be isolated from the fluid and extend along the exterior housing 23. Although the exterior housing 23 and an exterior surface of a battery chamber 35 are shown connected at the end, they need not be. This configuration produces stability and free battery chamber 35. Battery chamber 35 has an battery space 43 which is sized to accommodate any number of fitting batteries 37. Battery space 43 opens into a battery access opening 45 which may have any number of types of closures to keep the flashlight 21 in stable working condition.

Where the flashlight 21 is carried horizontally, the location of the heat rejection surface 31 will facilitate flow based upon any heated density difference in the fluid 39.

A great number of variations on the embodiment shown are possible and are likely to occur to workers and technicians in this field. These variations are considered to be comprehended by the present invention which is limited only by the following claims.

Although the invention has been derived with reference to particular illustrative embodiments thereof, many changes and modifications of the invention may become apparent to those skilled in the art without departing from the spirit and scope of the invention. Therefore, included within the patent warranted hereon are all such changes and modifications as may reasonably and properly be included within the scope of this contribution to the art.

What is claimed:

1. A high intensity flashlight comprising:
an exterior housing;
a battery chamber within and forming a fluid space with respect to said exterior housing;
a cooling fluid within said fluid space;
a high intensity light source supporting by said exterior housing and having a thermal transmission surface in fluid contact with said cooling fluid, said high intensity light source electrically switchably connected to batteries carried within said battery chamber.

2. The high intensity flashlight as recited in claim 1 wherein said exterior housing includes a clear window section to enable a user to view said cooling fluid.

3. The high intensity flashlight as recited in claim 2 wherein said cooling fluid includes particulate matter to enable a user to observe said cooling fluid through said clear window section to observe flow of said cooling fluid.

4. The high intensity flashlight as recited in claim 1 wherein said an exterior housing and said battery chamber are connected to each other distal to said high intensity light source.

5. The high intensity flashlight as recited in claim 1 wherein said high intensity light source is a high intensity light emitting diode.
